(19) United States
(12) Patent Application Publication
(10) Pub. No.: US 2013/0241157 A1
(43) Pub. Date: Sep. 19, 2013

(54) SCREW-BEARING GASKET

(71) Applicant: MANUFACTURA MODERNA DE METALES S.A., Barcelona (ES)

(72) Inventor: Jordi Priu Pont, Barcelona (ES)

(73) Assignee: MANUFACTURA MODERNA DE METALES S.A., Barcelona (ES)

(21) Appl. No.: 13/797,760

(22) Filed: Mar. 12, 2013

(30) Foreign Application Priority Data
Mar. 13, 2012 (ES) P201230381

(51) Int. Cl. F16J 15/06

(52) U.S. Cl. CPC F16J 15/061
USPC 277/609; 29/428

(57) ABSTRACT

The present invention discloses a sealing member comprising a main body and a sealing gasket. This sealing gasket is configured to retain the screws needed to assemble said sealing gasket. This simplifies the subsequent assembly of the sealing gasket and reduces logistical costs.

### FIELD OF THE INVENTION

The present invention relates to the field of screw retainers. In addition, the present invention relates to systems attached by screws that are transported using the screw retainers of the invention, such as vehicles comprising said systems.

### BACKGROUND

Several techniques are known for retaining screws coupled to elements to be screwed. As the transport of screws separately from the element to be screwed generally results in the loss of the screws, solutions have been developed whereby the screws can be transported loosely attached to the element to be screwed. This simplifies the assembly of the elements, as the screws are already arranged correctly. In addition, the loss of said elements during transport is prevented.

However, existing solutions generally maintain the union in a permanent manner. When attempting to couple these screws to fluid connection systems, such as pipes or automobile engines, the screws of the prior art are not appropriate, for the reasons described below.

A fluid connection is established by coupling two elements, where one of them is a subsystem of the vehicle (such as an engine, turbocharger, volumetric compressor, cooling system, etc.) and the other is a pipe subunit that carries fluids from one part of the vehicle to another. A person skilled in the art will understand that although in order to aid the understanding of the disclosure of the invention, a vehicle is mentioned and the subsystems generally present therein, the teachings of the invention are equally applicable to any other union of subsystems in which fluids pass, and where a tight union is therefore needed to ensure the sealing provided by a sealing gasket.

As the union between these two elements must be tight, the presence of a sealing gasket between them is necessary. These gaskets are made of metal in couplings where the ambient temperature or that of the fluid which is transported is high (above 200° C.), or when the outside medium or the fluid has aggressive properties (such as acids, oils, alcohols, fuels and the like) which can affect the chemical characteristics of the gaskets, causing them to degrade.

Also known are gaskets made of superimposed layers of ‘fibrous’ materials of ceramic nature (glass fiber, aramide and the like) and optional metallic layers that do not require specific sealing protrusions due to their low compression resistance. However, gaskets of this type are generally more expensive and recycling them entails greater difficulty than for gaskets that are 100% metallic.

A metallic gasket has at least one protrusion above its plane, such as a continuous projection rib that surrounds or delimits the area through which the fluid will pass from the pipe to the subsystem, or vice versa, to ensure tightness. This protrusion must exert a contact pressure on the interfaces that compress it which is substantially greater than the internal pressure of the fluid it is delimiting. Ideally, the contact pressure is elastic in nature.

To obtain this contact pressure, compression loads provided by screwed unions are generally used. It is common for the female thread of the screwed union to belong to the subsystem related to the vehicle. In specific cases, the gasket may include attachment elements so that it is integrally joined to the pipe subsystem by a folding of said elements.

In the vast majority of architectures of the pipe subsystem, this ends in a flange, banjo or elbow shape with a significant stiffness level, able to convert very efficiently the axial loads of the screws to compression loads of the sealing rib.

This efficient conversion is related to a high bending inertia module about the axis defined by the centres of the screwed areas, in the end element (banjo, flange, elbow etc.) of the pipe subsystem. The inertial module is proportional to the distance (thickness) of the end element. On the other hand, the weight and cost of the end component is also proportional to it, so that this is a limiting design parameter.

Similarly, maximum efficiency is achieved by reducing the friction torque opposing the rotation of the screw in the screwing process, so that the nominal torque is maximally converted into a compression axial load. These fiction torques are affected by both the contact cross-section and the coefficients of friction between materials.

FIG. 1 shows a cross-sectional view of a sealing joint 100 of the state of the art, where a sealing member 101 is mounted on a subsystem related to the vehicle 102. The sealing joint is used to connect a pipe 103 in which flows a liquid 104. The sealing member 101 comprises a flange as its main body 105 and a sealing gasket 106. In the area 107 where liquid flows, the sealing gasket presents a protrusion 108 that delimits said area 107. The sealing member 101 is assembled using a screw 109 threaded in a female thread 110 of the subsystem 102 related to the vehicle. Members of this type have the common drawback that they cannot retain screws.

In the case of these sealing members, the friction torques appear mainly in two places. The friction torque associated to the contact 111 of the threads of the screw and female, and the friction torque associated to the contact 112 between a stopping means such as a flange, which is a type of lip, or a washer of the screw head and the outer plane of the flange. This friction torque appears in the final stage of tightening and is directly proportional to the desired tightening force, being particularly high in case of lack of flatness of the contact area or lack of perpendicularity of the screw axis and the outer plane of the flange, as in these cases local contacts occur between the screw and the flange that can dramatically increase the friction torque. This effect is generally undesirable, as it considerably reduces the force transmitted to the sealing rib. The greater force needed to compensate for this loss results either in a less comfortable assembly or an undesired arrangement of the assembly tools. Therefore, there is a need to provide a system that facilitates the assembly of the screw while providing maximum tightness.

On another hand, if the transmission force to the sealing rib is not sufficient, liquid leaks can occur leading to engine malfunction. Moreover, as the sealing gasket is generally located in a hard to reach area with poor visibility for the worker who must assemble it, it is not possible to check whether the position of the screw and therefore the resulting seal is correct. Therefore, there is also a need to provide a system that allows the operator to assembly a sealing member in a simple manner that fulfills the necessary quality requirements.

An additional drawback of current systems is the limitation resulting from having to first place in position the sealing gasket with the flange and then place and mount the screws. This two-stage assembly is a slow process. Furthermore, as stated above, the pipe subsystem is generally located in an area that is hard to reach and has poor visibility. It is sometimes even in a position that cannot be reached with the hand, but only with a screwdriver or other assembly tool. Consequently, there is also a need to provide a system that facilitates the assembly of the sealing member, making it quicker, easier, and more reliable, even if the worker cannot check it.

### SUMMARY OF THE INVENTION

All of the aforementioned drawbacks are solved by means of an optimised sealing member. In one embodiment of the invention, a sealing member is disclosed of the type coupled to another member through which liquids flow. The sealing member comprises a main body and a sealing gasket coupled to the main body. This sealing gasket is configured to retain screws.

In another embodiment of the invention, a system is disclosed for liquid circulation that comprises the sealing member, wherein said system is selected from the group consisting of an engine, a turbocharger, a volumetric compressor, a cooling system or a heating system. A person skilled in the art will understand that the sealing member of the invention can be coupled and used also with other systems not explicitly mentioned, provided that these systems involve the flow of fluids and require assembly by screws and a gasket to prevent fluid leakage.

Another embodiment of the invention discloses the use of the sealing member in the manufacture of a system for liquid flow and a vehicle comprising said system for liquid flow.

### BRIEF DESCRIPTION OF THE DRAWINGS

FIG. 1 shows a sealing member belonging to the state of the art by way of example.

FIG. 2 shows a sealing gasket by way of example.

FIG. 3 shows a sealing member according to one aspect of the invention.

FIGS. 4A-4F show different arrangements of the retention hole in the sealing gasket according to another aspect of the invention.

FIG. 5 shows a retention hole according to one aspect of the invention by way of example, configured to be embedded in the hole of the flange.

FIGS. 6A-6D show a sealing member according to an aspect of the invention that comprises a sealing gasket with lateral flaps.

FIG. 7 shows a retention hole according to an aspect of the invention in a flap that is open towards the end of the flap.

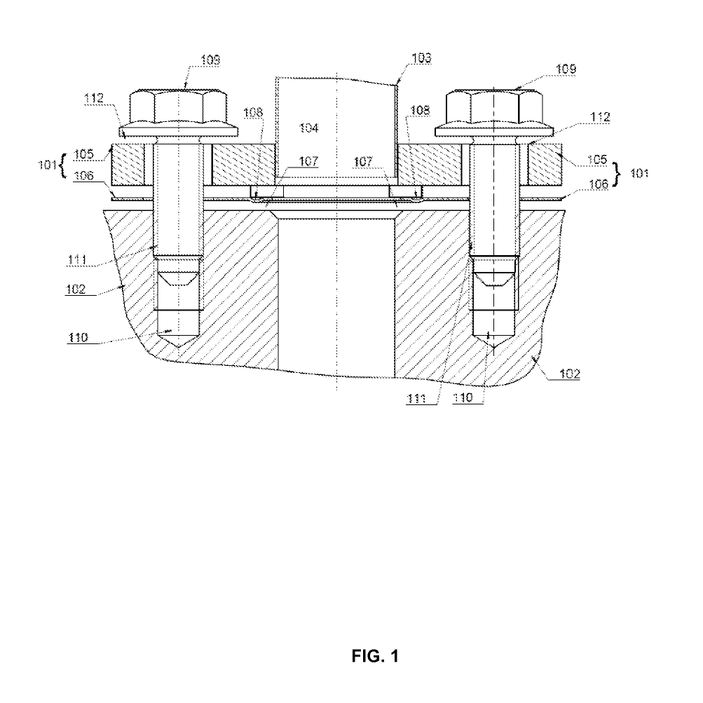

### DETAILED DESCRIPTION OF THE INVENTION

The sealing member disclosed by the present invention solves the drawbacks of the prior art. The member is configured such that it retains the screws needed for its subsequent assembly in a manner that makes them be properly arranged, thereby facilitating the assembly, as well as in the correct position to provide maximum tightness.

The sealing member is of the type screwed onto another element. This sealing member is used in systems in which liquids flow, such as water, oil, gasoline or others. The sealing member comprises a main body and a sealing gasket mounted on the main body, wherein the gasket is configured to retain the screws needed to assemble said sealing member. The main body can be any object comprising openings for screws to pass and openings for fluids to pass, which can be coupled by screws to another body to establish a union between pipe subsystems. Preferably, the main body is a flange, although as stated it can also be another element through which fluids pass and needs to be screwed to ensure the union between the two elements.

Metal gaskets are preferred for the sealing gaskets due to their lower cost and better recycling compared to gaskets made of superimposed fibrous materials. In addition, metal gaskets have the advantage of withstanding high temperatures, such as above 200° C., or external mediums or internal fluids with aggressive properties, such as acids or alcohols, thereby preventing the degradation of the gasket.

Metallic gaskets can be of the plasticising type, such as made from copper/aluminum or soft materials, or gaskets with spring-effect. These latter metal gaskets are preferably made of steel with a high elastic limit or stainless steel, with a thickness of less than 1 mm, preferably 0.4 mm, and can have coatings of organic materials such as acrylics, neoprene, fluorides or others with a thickness of tenths of micron.

The gasket has at least one protrusion above its plane, such as continuous projection or rib that surrounds or delimits the surrounding area through which the fluid will pass from the pipe to the subsystem, or vice versa. This rib is responsible for the tightness, and must exert a contact pressure, ideally elastic, on the interfaces that compress it which is substantially greater than the internal pressure of the fluid it is delimiting.

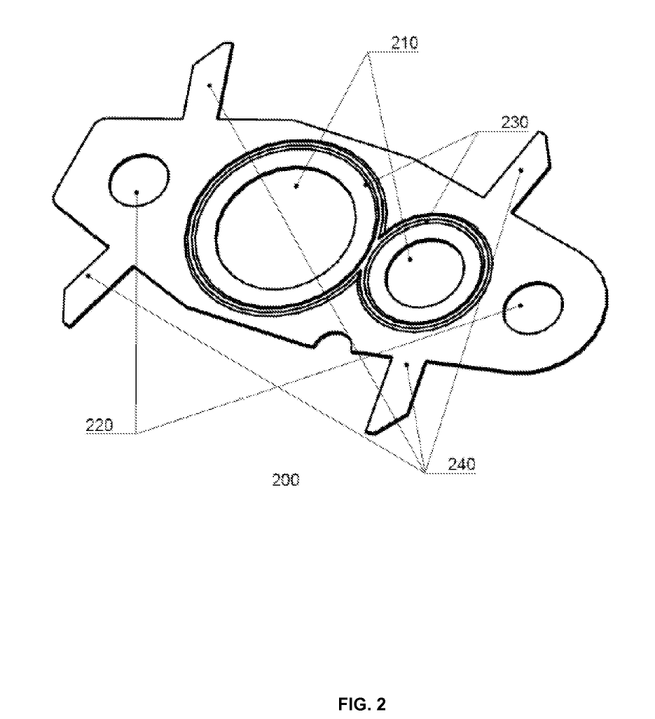

A sealing gasket is shown by way of example in FIG. 2. This gasket 200 has two openings 210 through which the liquid flows and two openings 220 through which the screws pass for the subsequent assembly. Around the flow openings 210 are one or more ribs 230 that delimit or surround the flow area and provide tightness. In one aspect of the invention, the gasket 200 has some attachment elements 240 that are arranged perpendicular to the central axis of the gasket 200. In another aspect of the invention, there are also gaskets 200 with attachment elements 240 in the lateral positions, that is, in the direction of the central axis of the gasket 200. The most common method used to manufacture the metal gaskets is a gradual stamping process with a matrix. The final cost of the gasket is proportional to the size of its cutting length, that is, proportional to the size of the blank needed to make it.

Because the sealing gaskets of the present invention are configured to retain the screws needed for subsequent assembly in a manner that they are already in place, thereby facilitating the assembly, as well as in the correct position to provide maximum tightness, the following drawbacks are solved.

The time invested by the final customer (assembler of the pipe subassembly to the car or engine) is reduced as the screws are already in their final assembly position, eliminating the stage requiring gathering and positioning the screws. They only need to be tightened to the appropriate torque. This is particularly advantageous because normally the pipe assembly is in a position that is hard to reach and has poor visibility, and sometimes cannot even be reached by the hand.

In this way, the risk is reduced of a screw falling and being lost during the assembly operation while the operator handles it. It also eliminates the risk of forgetting a screw. This is particularly advantageous in couplings with more than one screw.

In addition, it is possible to eliminate purchasing references by the customer and the need for logistic adjustment between the number of screws and the number of pipe subsystems, which results in fewer administrative tasks and the corresponding reduction in logistics human errors. The presence of the screws guarantees uniquely the presence of the sealing gasket in the system, so that it is impossible to assemble a pipe subsystem without a gasket. The positioning of the sealing rib is more accurate, as it is referenced with respect to the axis (axes) of the screw(s).

In an embodiment of the invention, to retain the screws in the sealing system the concept uses the holes through which the attachment screws pass to adjust the screw thread, so that the screws are locked in a subtle manner. These holes are called retention holes. This allows delivering said screws pre-mounted to a system, such as a flange-gasket, facilitating the assembly by the customer and improving the positioning of the screws to obtain maximum tightness.

In several embodiments and aspects of the invention, various methods for retaining the screw in the sealing system, specifically in the gasket, have been developed. All of these methods have in common that every screw is retained in a specific hole of the gasket provided for the screw to pass.

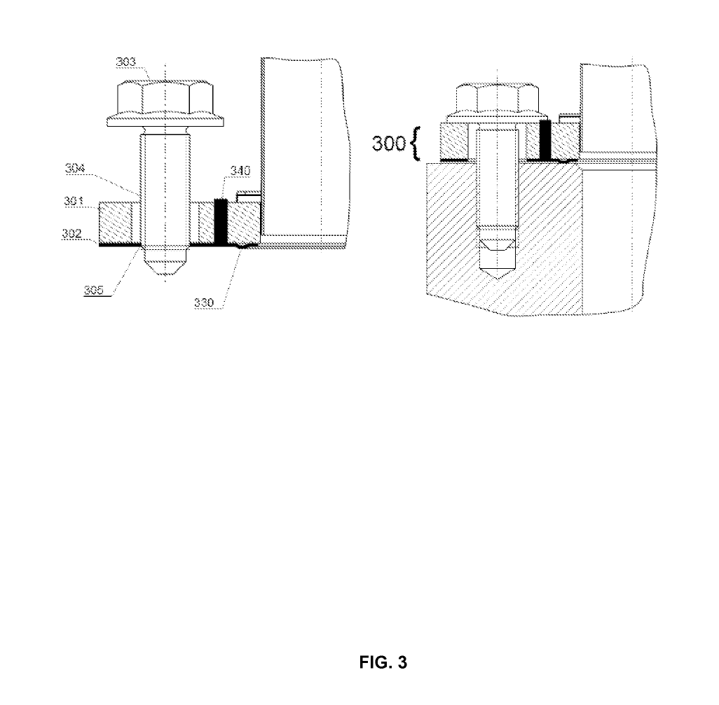

FIG. 3 is a cross-sectional view of an embodiment of the invention showing a sealing member 300 during its transportation (left) and once assembled (right). The sealing member 300 comprises a main body 301, preferably a flange, and at least one gasket 302 configured to retain screws 303. The gasket 302 is based on the gasket 200 of FIG. 2 and it is mainly flat and located entirely under the contact surface of the main body 301 with attachment elements 340 that allow assembling the gasket 302 on the main body 301.

The gasket 302 presents a retention hole 305 that is configured so that the screw 303 is retained in the hole 305 by its thread 304 and cannot pass freely through it. Preferably, the retainer hole 305 has a diameter that corresponds to the diameter of the screw 303.

In an aspect of the invention, the attachment elements 340 are clipping tabs that protrude laterally and retain the gasket 302 on the main body 301. More specifically, said clipping tabs are in a position perpendicular to the main axis of the gasket 302, which can penalise the final cost of manufacturing the gasket 302 as the cutting progress is greater. However, this position is typically the only possible one to prevent contact of the clipping tabs with the base of the screw, as it could hinder or interfere with a correct screwing. Therefore, in this aspect an improved screwing is obtained at the expense of a higher production cost.

In another aspect of the invention, the attachment system can be lateral flaps that can be folded to rest above the main body 301, either directly or with a separation between the folded flap and the main body 301. The attachment of the gasket 302 to the main body is achieved by the flap alone and/or in combination with the screw. In addition, the flaps can also have a hole for an attachment screw to pass.

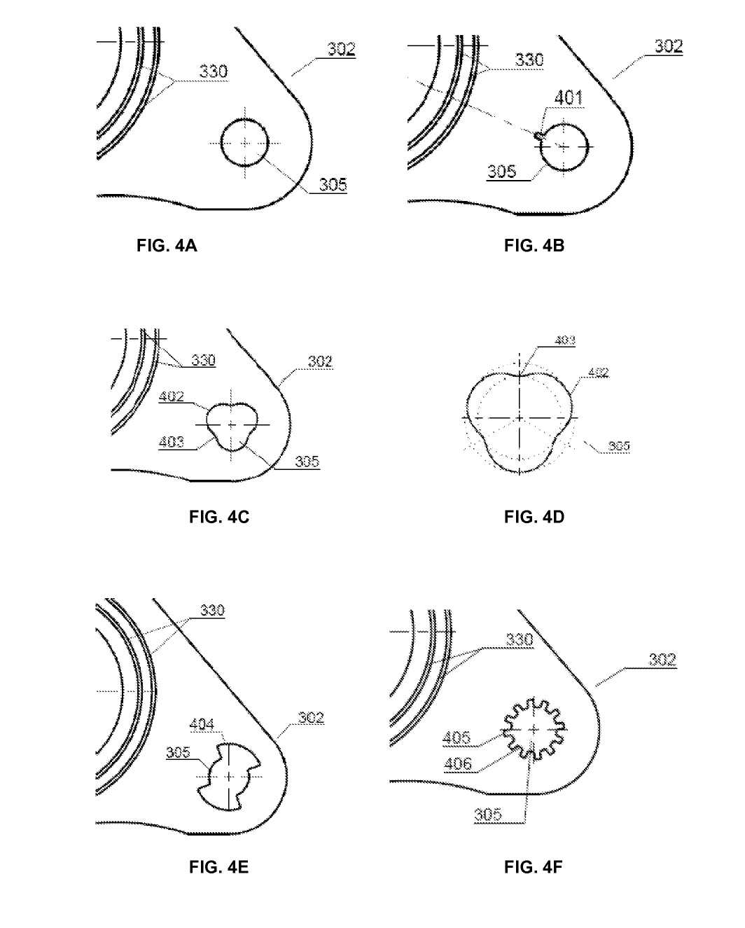

According to another aspect of the invention, the retention holes 305 in the gasket 302 through which pass the screws 303 can use the current geometry of the hole 305 through which pass the screws, as shown in FIG. 3 or FIG. 4A which show a retention hole 305 by way of example. This improves the diametric accuracy, so that the screw 303 is threaded in the hole 305 using the small thickness of the gasket 302, normally about 0.4 mm, as a threading.

However, this method can have the drawback of the constant contact of the (helical) threading of the screw 303 and the plane of the gasket 302, which induces a torsion as the gasket 302 must adapt to the profile of the threading 304. Depending on the distance between the hole 305 and the sealing rib 330 this parasitic torsion can affect the flatness of the rib 330, compromising the effectiveness and uniformity of the contact pressure.

Therefore, in another aspect of the invention it is possible to minimise this effect by introducing threading openings in the retention hole 305 which are conveniently located in the direction towards the sealing rib 330. A retention hole 305 of this configuration is shown by way of example in FIG. 4B. These openings minimise the effect of the parasitic torsion on the flatness of the rib 330. As can be seen, the retention hole 305 presents a circular geometry that is interrupted by a small opening 401.

In another aspect, a modification is made of the perfectly circular geometry of the hole 305 of the gasket 302, as can be seen in FIGS. 4C to 4F. The hole 305 can be improved by using said modified geometry with lobes, helical arcs, crenellations by way of a washer or others. In these cases it is possible to reduce the screwing friction, resulting in a simpler assembly of the screws 303 in the gasket 302 as well as an improved positioning of the screw 303 to achieve maximum tightness.

A substantially circular geometry of the hole 305 provided with lobes 402 is shown by way of example in FIGS. 4C and 4D. FIGS. 4C and 4D show a retention hole 305 with three lobes 402. The maximum diameter of the hole 305 is greater than the diameter of the screw 303, but there are still three contact points 403 corresponding to the diameter of the screw 303. This is shown in detail in FIG. 4D.

The lobes 402 reduce the points of contact 403 of the gasket and the screw. A geometry with three lobes has been shown to be ideal. A small number of contact points 403 leads to a lower screwing friction. This lower screwing friction facilitates the entrance of the initial thread of the screw 303.

In another aspect a substantially circular geometry is used with an interruption compatible with the stamping process, to generate two opposing arcs at the bottom of the thread, which also reduce the number of contact points. This configuration of the retention hole 305 is shown in FIG. 4E. The position of the arcs 404 is not limited, so that they can be located anywhere around the retention hole 305.

These arcs 404 can be helically shaped or have a minimum stiffness so that they adapt during the screwing to the helix of the screw 303. As in the shape with lobes 402, the screwing friction is reduced and the insertion of the initial thread of the screw 303 is facilitated.

Yet another aspect uses a geometry in which the hole 305 can have crenellations by way of a retaining washer. The configuration of this retention hole 305 is shown in FIG. 4F. As can be seen, there are multiple openings 405 (not all shown) in the retention hole 305. This also reduces the contact points 406 (not all shown) of the gasket 302 and the screw 303.

In this way, the screws 303 can be retained by a slight interference and friction. In addition, the result is a simpler insertion of the screw 303 in the initial thread 304 of the screw 303 and an improved positioning of said screw 303 for the subsequent assembly. In this case the crenellated area 405 can be flat or embedded in the hole for the screws to pass in the main body 301.

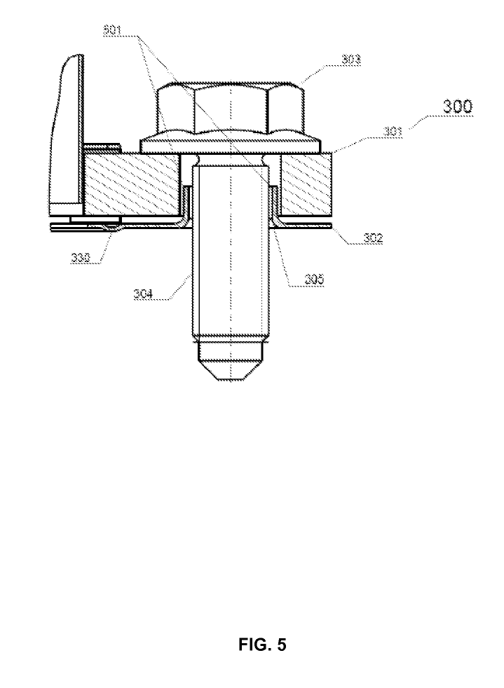

FIG. 5 shows a configuration for the retention hole 305 according to another aspect of the invention. In this aspect the substantially circular modified geometry is changed, using instead a retention hole 305 configured so that it allows embedding 501 part of the gasket 200 in the hole of the main body 302. In this way, more threadings are provided to attach the screw 304, thereby improving its immobilisation. Although the embedding 501 is shown from the bottom, an embedding from the top is equally applicable in another aspect of the invention. The embedding 501 can range from some microns to a few millimeters. In one aspect of the invention, the embedding 501 in the holes of the main body 302 has at least 1 mm.

The sole requirement for the retention holes 305 described above is that their position match that of the hole for passage of the screws in the main body 301. Therefore, the retention hole 305 can be provided either under the main body 301, that is in the sealing plane, or above the main body 301, parallel to the sealing plane. In the latter case the holes 305 are provided in lateral flaps that can be folded to rest above the main body 301, either directly or with a separation between the folded flap and the main body 301.

If the retention holes 305 are under the main body, there is a risk of detachment of metal particles or of the coating of the gasket 302 when screwing the screw 303. These particles can interfere with the functioning of the fluid system, or contaminate this fluid. This particle detachment can be minimised by using the modified circular geometries, that is, when the hole 305 has lobes 402, arcs 404 or crenellations 405.

Another risk related to a retention hole 305 located under the main body is an insufficient preassembly of the screw 303, as can be seen in FIG. 3. Only a short length of the screw 303 can be screwed so that it does not protrude excessively from the sealing plane, which would hinder the final assembly by the customer. This minimum screwing therefore lacks robustness, as there is the added risk that the typical vibrations of moving vehicles will make the screw 303 come loose during transport, making it fall and losing the screw 303 during transport or handling.

Therefore, in another aspect of the invention the retention hole 305 is placed above the main body 301 to minimise said risks. In this way, the screw 303 can be screwed at least by the thickness of the main body 301, which is normally from 4 to 10 mm, so that it is retained in a more central and thus more robust manner, solving the problem of falling and preventing logistical problems.

In yet another aspect of the invention, it is possible to place a retention hole both above and under the main body. This requires the gasket 302 to have at least four openings for a screw to pass, configured to retain said screw. The retention holes in this aspect of the invention can be combined with all the aspects described above in relation to FIGS. 4A-4F and with the aspect of the embedding of FIG. 5. In addition, the retention holes in this aspect can consist of any combination of these aspects, that is, there can be an embedding on the top and on the bottom, or an embedding on the top and a modified hole on the bottom.

To provide a retention screw above the main body 301, a gasket is used with lateral flaps that is configured to house said flaps after they are folded above the main body 301. The flap can be directly above the main body 301, that is, touching the main body 301, or there can be a separation between the main body 301 and the flap. In any case, the folded flap is parallel to the sealing plane of the gasket.

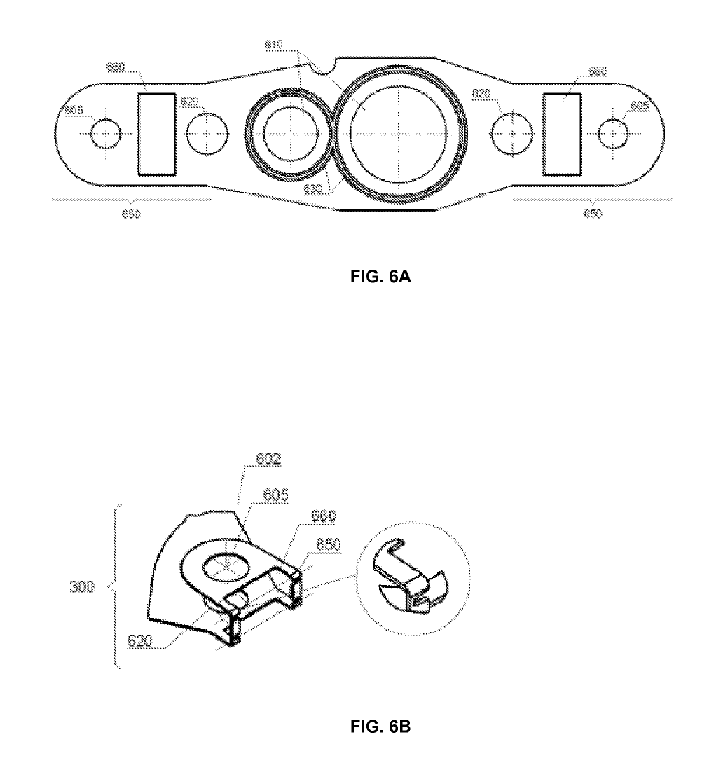

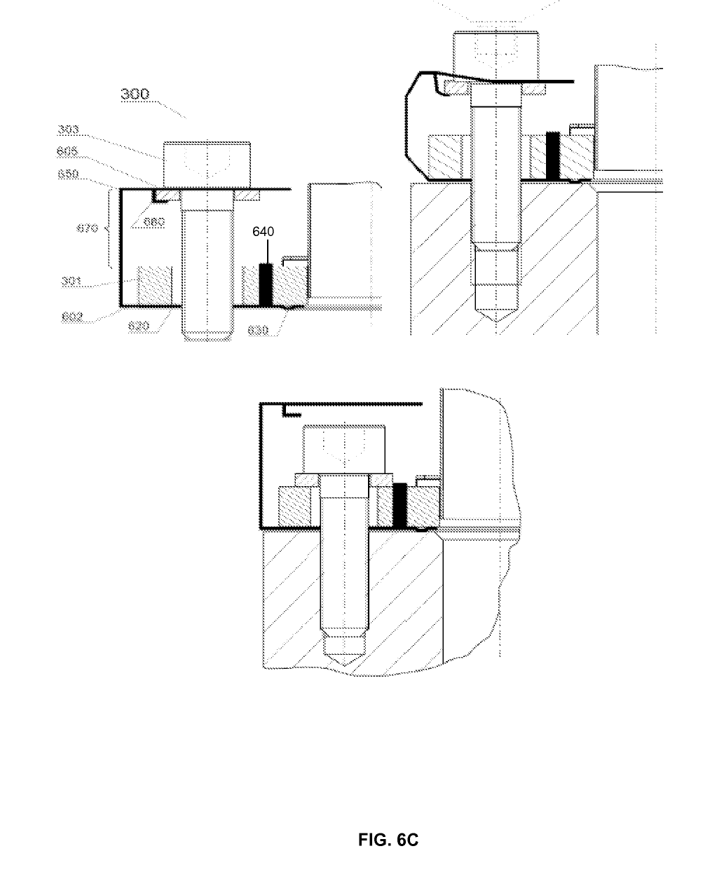

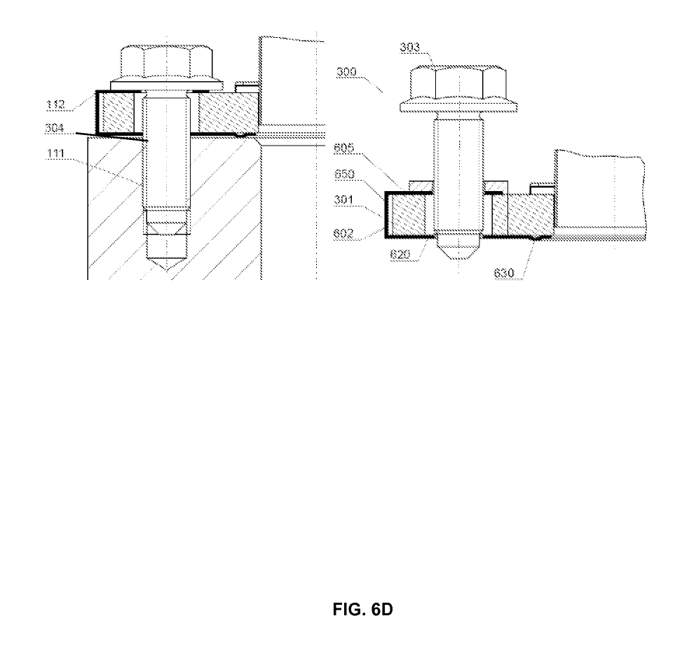

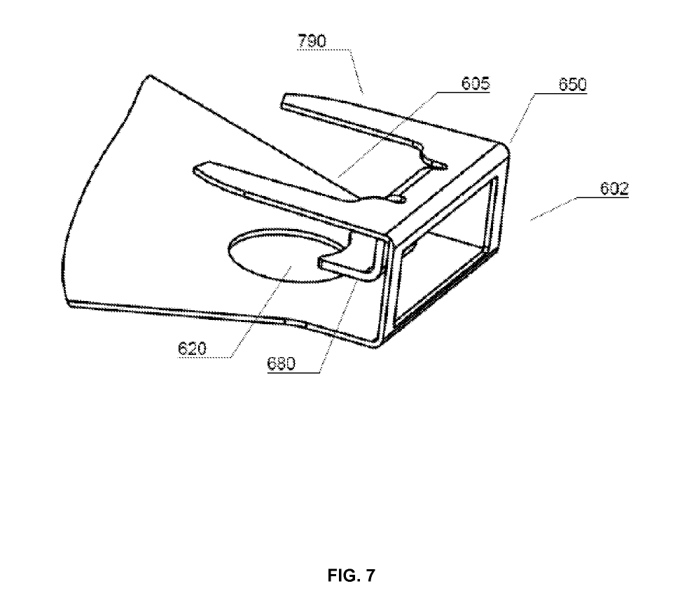

A sealing gasket 602 according to this configuration is shown by way of example in FIG. 6A. The gasket 602 is also based on the gasket 200 of FIG. 2. In addition to the flow openings 610, protrusions 630 and the openings 620 for the screws to pass, it shows two flaps 650 in lateral position, that is, in the direction of the main axis of the gasket. These flaps 650 each have a hole 605 for a screw 303 to pass before passing to the main body 301 (not shown). In this example of gasket 602, there is also a gap 660 in the connection between the flaps 650 and the gasket 602 that provides greater flexibility to the folded flap 650. This gap 660 is shown in greater detail in FIG. 6B. Optionally, there can be some clipping tabs 640 (not shown) in case the separation between the sealing plane and the flap plane is greater than the width of the main body 301.

In this configuration the screw 303 goes through two holes 620, 605 in the gasket 602. The bottom hole 620, placed in the sealing plane, is clearly larger than the outer diameter of the screw 303, preventing any contact with it. In this way it cannot interfere with the screw 303 and its positioning. In addition, no particles can be detached from the gasket 602 or its coating if applicable. The top holes 605 represent the retention holes in which the screw 303 is threaded. In addition, these retention holes 605 can have all the features described above and illustrated in the FIGS. 4B-4F or FIG. 5 to reduce the screwing friction, such as the lobes 402, the arcs 404, the crenellations 405 or the embedding 501 or to improve the retention.

In another aspect of the invention a separation 670 is provided between the flap 650 and the main body 301 such that the fold is higher than the width of the main body 301. An example of this configuration is shown in FIG. 6C. In any case the configuration in which the folded flap 650 is located under the head of the screw 303 is maintained. However, to attach the gasket 602 to the main body 301 it is necessary to provide it with attachment elements 640 in the form of clipping tabs, since the flap 650 cannot be used for this.

According to FIG. 6C there are several ways to retain the screw 303. The screw 605 of the flap 650 can have any of the aspects described above in relation to the FIGS. 4A-4F or FIG. 5, such as the geometry of the hole corresponding to the geometry of the screw, or its improvements regarding a small number of contact points, such as a hole with lobes 402, with helical arcs 404 or crenellations 405 in the form of washers.

Therefore, the screw 303 is threaded in the flap 650 until it reaches the through hole in the main body 301. In addition, the retention hole 605 in the flap 650 can have one or more clips 680 that are located on the lower plane of the flap 650. Said clips 680 can retain the screw 303 by its head, preferably using a stopping means such as a flange or washer. In this way, said flange or washer of the screw 303 is retained between its two faces by the gasket 602.

Using said one or more clips 680, it is even possible to use a retention hole 605 having a diameter considerably greater than the thread 304 of the screw but smaller than the stopping means of the screw. This establishes a stop contact that allows blocking in the removal direction of the screw 303. However, the assembly direction is not affected in any way, as shown in FIG. 6C.

In another aspect of the invention, the flap 650 can comprise a retention flap 790 having an open end towards the flap 650 as shown in FIG. 7. This specific example shows the flap 650 with the retention hole 605 that is substantially larger than the thread diameter of the screw 303 and a clip 680 under the plane of the flap 650 for retaining said screw 303.

In addition, the attachment area will be suitably weakened to aid the bending and the unclipping process of the screw 303, as also shown in FIG. 6B. The advantage is found here that no friction torque opposes the screw tightening torque, as the screw 303 is unclipped (disarranged) in the initial moments of the screwing.

However, this configuration of the flap 650 with a fold that is wider than the main body 301 has a series of drawbacks. On one hand, the gasket 602 requires some attachment elements 640, preferably in the form of clipping tabs 240, to assemble it on the main body 301. This implies a greater cutting progress and a higher cost of manufacture of the gasket. In addition, the flap 650 remains after the assembly in a position above the screw 303, which hinders the unscrewing process. A further drawback of this top position of the flap 650 is that contacts and noises of the flap 650 with its surroundings may occur due to the vibrations of the engine.

Therefore, it can be desirable to place the flap 650 directly above the main body 301 as shown in FIG. 6D. This figure shows that the bottom hole 620 is greater than the diameter of the thread of the screw 303, while the diameter of the retention hole 605, the top hole, is the same as the diameter of the thread of the screw 303. It can also be seen that the flap 650 is located directly above the main body 301.

In addition, the configuration of FIG. 6D allows reducing the friction torque due to the reduction of the coefficient of friction between the interfaces, thereby improving the transmission efficiency of the axial loads of the screws 303 on the sealing rib 630. This reduction in friction is particularly apparent when the flap 650 of the sealing gasket 602 is interposed between the stopping means of the head of the screw 303 and the outer plane of the main body 301, that is, when the flap 650 is between the main body 301 and the head of the screw 303.

In addition, in the case that the flaps 650 are between the main body 301 and the head of the screw 304, these flaps 650 are also employed to attach the gasket 602 to the main body 301. In this aspect, attachment elements 640 such as the clipping tabs 240 are not essential for achieving the retention, allowing the cutting progress and the cutting remains to be lower, improving the cost.

Thus, when the flaps 650 are between the main body 301 and the head of the screw 303, a new contact surface is generated between the gasket 602 and the head of the screw 303. An advantageous use can thus be made of the coefficient of friction of the material of the gasket 602 and the intrinsic flatness of the flap, reducing the friction torque against the tightening torque, in order to optimise the efficiency of the tightening torque on the sealing rib 630.

However, when the tightening torque is applied during screwing due to the friction 112 between the head of the screw 303 and the flap 650 of the gasket 602, a torsional torque is introduced on the flap 650 that must be compensated by the resistance of the gasket 602, possibly affecting the sealing plane and twisting it. In another aspect of the invention, in order to reduce this transmission, the connection area between the top and bottom parts of the gasket 602, that is between the folded flap 650 and the sealing plane, has a minimised cross-section as shown in FIG. 6B.

In this way the deformation is concentrated on the connection sections, when necessary presenting at least one additional notch 660 by which the flap 650 would break due to the torsional torque, in these cases making independent the two areas of the gasket 602 by a certain force of tightening torque. However, this will not affect the secure retention of the screw 303.

All aspects of the specific configurations of the retention hole 305, 605, specifically as described with reference to FIGS. 4A-4F and FIG. 5 can be used in any of the gaskets 200, 302 or 602. All of these aspects can be used in a retention hole 305, 605 located under, above or on both sides of a main body 301. In the latter case, all combinations of the aspects described with reference to FIGS. 4A-4F and FIG. 5 are possible.

The description comprises several embodiments by way of example. As it is neither possible nor practical to describe in detail the full variety of combinations and permutations of the inventive concept, which would lead to a large number of embodiments and redundant paragraphs, the author understands that a person skilled in the art, after a direct and objective examination of this specification, would arrive at the different possible permutations and combinations of the various embodiments and aspects described. Consequently, the main embodiments and aspects have been described, in the understanding that they include the remaining combinations, variations and modifications, provided they fall within the scope of protection as defined by the claims. Therefore, a person skilled in the art would understand that the description of the embodiments provided does not limit the invention, nor do the drawings.

1. Sealing member of the type coupled to another member, both members being configured to allow the flow of liquids and coupled by attaching screws, the sealing member comprising:
at least one main body; and
at least one sealing gasket mounted on the at least one main body;
the at least one sealing gasket being configured to retain the screws that attach said members.

2. Sealing member according to claim 1, wherein the main body is a flange.

3. Sealing member according to claim 2, wherein the sealing gasket presents protrusions that limit the flow area.

4. Sealing member according to claim 3, wherein the sealing gasket is made of metal, preferably of the plasticising type or with a spring effect.

5. Sealing member according to claim 4, wherein the configuration used to retain the screws is one or more retention holes in the sealing gasket.

6. Sealing member according to claim 5, wherein said retention holes present a diameter that matches the diameter of the screw to be mounted.

7. Sealing member according to claim 6, wherein said retention holes further present an opening oriented towards the protrusions.

8. Sealing member according to claim 6, wherein said retention holes have a modified circular geometry configured to reduce the screwing friction.

9. Sealing member according to claim 8, wherein said modified circular geometry presents lobes, arcs or a crenellation by way of a washer.

10. Sealing member according to claim 9, wherein the crenellation by way of a washer can be in the plane with the retention hole or embedded in the hole of the flange.

11. Sealing member according to claim 5, wherein said retention holes are configured to be embedded for at least 1 mm in the hole for passing a screw in the flange.

12. Sealing member according to claim 5, wherein said retention holes are located in the sealing plane or in lateral folded flaps of the gasket parallel to the sealing plane, with a separation between them corresponding to at least the width of the flange.

13. Sealing member according to claim 12, wherein said retention holes are located in some folded flaps of the gasket parallel to the sealing plane, with a separation between them corresponding to the width of the flange.

14. Sealing member according to claim 12, wherein said retention holes are located in some folded flaps of the gasket parallel to the sealing plane, with a separation between them that is greater than the width of the flange.

15. Sealing member according to claim 14, wherein said retention holes further have one or more clips for attaching the screw stopping means.

16. Sealing member according to claim 15, wherein said retention holes are open towards the end of the flap.

17. Sealing member according to claim 1, also comprising the screws for its subsequent assembly.

18. A system for liquid circulation comprising the sealing member of claims 1-17, wherein said system is selected from the group consisting of an engine, a turbocharger, a volumetric compressor, a cooling system or a heating system.

19. Use of the sealing member of claims 1-17 to manufacture a system for liquid circulation that facilitates the assembly of the system.
